(19) United States
(12) Patent Application Publication
(10) Pub. No.: US 2003/0122324 A1
(43) Pub. Date: Jul. 3, 2003

(54) Sealing packing for sealing cap and pneumatic stapleer gun

(76) Inventor: Ming Hsien Chen, Taichung City (TW)

Correspondence Address: Hart, Baxley, Daniels & Holton, Fifth Floor, 59 John Street, New York, NY, 10038, US

(21) Appl. No.: 10/227,512

(22) Filed: Aug. 26, 2002

(30) Foreign Application Priority Data
Dec. 31, 2001 (TW) 090224829

(51) Int. Cl. F16J 15/02

(52) U.S. Cl. 277/637

(57) ABSTRACT

A seal packing for pneumatic stapler includes a stiff inner layer and a soft outer layer which wraps the stiff inner layer. Four protrusions extend from an inner periphery of the seal packing and each protrusion has a hole defined therethrough. The seal packing is sandwiched between the cap and the body of the pneumatic stapler, screws extend through the cap, the holes in the seal packing and are engaged with holes in the body of the stapler.

### FIELD OF THE INVENTION

The present invention relates to a seal packing that has a stiff inner layer and a soft outer layer through which holes are defined for the screws extending.

### BACKGROUND OF THE INVENTION

A conventional pneumatic stapler uses pneumatic force to eject the staples out from the stapler and in order to ensure there is no leak between the parts of the stapler, a seal packing is used between the cap and the body of the stapler. The seal packing is generally made by Asbestos which is firmly sandwiched between the cap and the body of the stapler so as to prevent any leaking of the air entering the body of the stapler. It is experienced that the Asbestos seal packing is broken when detaching the cap the body apart to proceed maintenance, and frequent replacement of the seal packings increases the expense of maintenance.

The present invention intends to provide a seal packing that includes a stiff inner layer and a soft outer layer, the soft layer ensures the sealing function and the stiff layer ensures the seal packing has strong structural strength.

### SUMMARY OF THE INVENTION

In accordance with one aspect of the present invention, there is provided a seal packing for pneumatic stapler wherein the seal packing comprises a stiff inner layer and a soft outer layer which wraps the stiff inner layer. The soft layer seals the gap between the cap and the body of the stapler, and the stiff layer prevents the seal packing from being torn apart.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the cap, the seal packing of the present invention and the body of the stapler, and

FIG. 2 is a cross sectional view to show that the seal packing is sandwiched between the cap and the body of the stapler.

### DETAILED DESCRIPTION OF THE PREFERRED EMBODIMENT

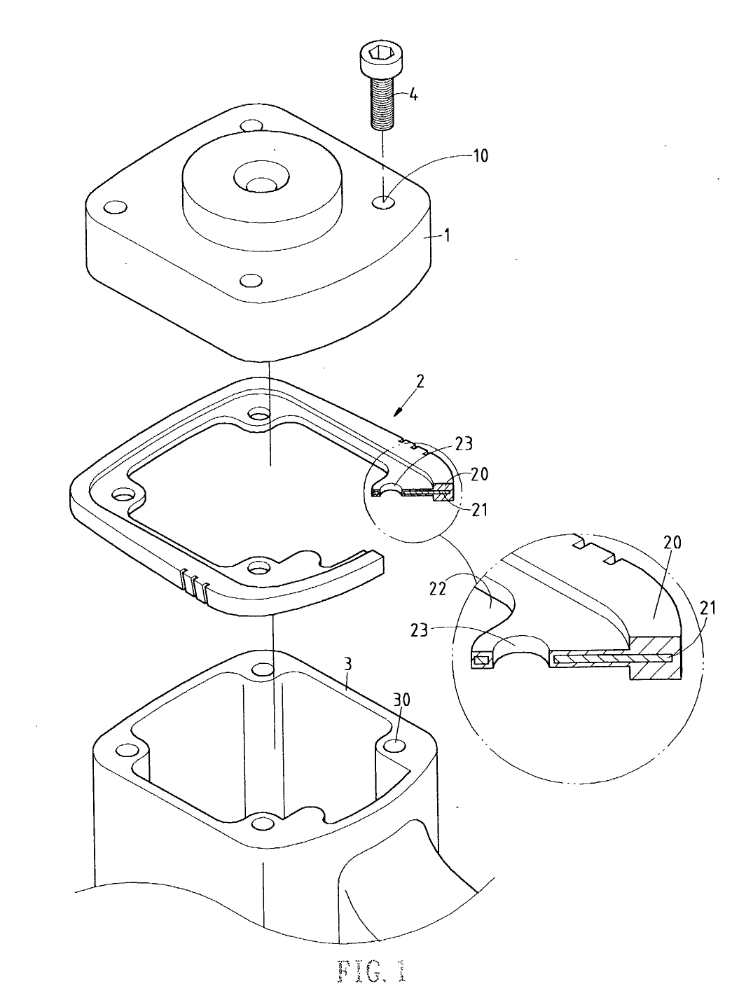

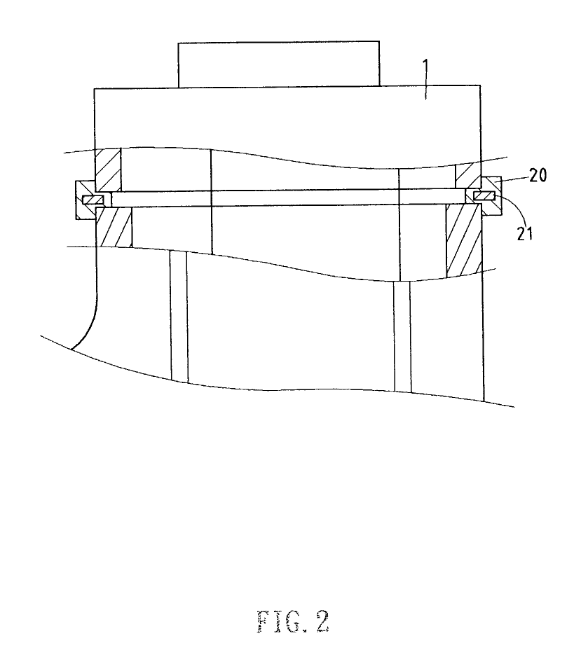

Referring to FIGS. 1 and 2, the seal packing 2 of the present invention is a rectangular member with a central hole and sandwiched between a cap 1 and a body 3 of the stapler. The seal packing 2 comprises a stiff inner layer 21 and a soft outer layer 20 which wraps the stiff inner layer 21. Four protrusions 22 extend from an inner periphery of the seal packing 2 and each protrusion 22 has a hole 23 defined therethrough.

Screws 4 extend through holes 10 in the cap 1, the holes 23 in the protrusions 22 and are engaged with the holes 30 in the body 3 of the stapler as shown in FIG. 2. The soft outer layer 20 has proper thickness and is deformed and squeezed to fill the gap between the cap 1 and the body 3 of the stapler. The soft outer layer 20 ensures that no leakage between the cap 1 and the body 3 of the stapler 3. The stiff layer 21 reinforces the structural strength of the seal packing 2 so that when detaching the cap 1 and the body 3 of the stapler 3, the seal packing 2 is not torn apart.

While we have shown and described the embodiment in accordance with the present invention, it should be clear to those skilled in the art that further embodiments may be made without departing from the scope of the present invention.

What is claimed is:

1. A seal packing for pneumatic stapler, comprising:
a stiff inner layer and a soft outer layer which wraps the stiff inner layer.

2. The seal packing as claimed in claim 1, wherein four protrusions extend from an inner periphery of the seal packing and each protrusion has a hole defined therethrough.
